(19) United States
(12) Patent Application Publication
(10) Pub. No.: US 2021/0343288 A1
(43) Pub. Date: Nov. 4, 2021

(54) KNOWLEDGE ENHANCED SPOKEN DIALOG SYSTEM

(71) Applicant: Robert Bosch GmbH, Stuttgart (DE)

(72) Inventors: Zhengyu ZHOU, Fremont, CA (US); Vikas YADAV, Tuscon, AZ (US); Yongliang HE, Atlanta, GA (US); In Gyu CHOI, Atlanta, GA (US)

(21) Appl. No.: 16/862,626

(22) Filed: Apr. 30, 2020

(51) Int. Cl. G10L 15/26; G10L 15/197; G10L 15/18; G10L 25/63

(52) U.S. Cl. CPC G10L 15/26; G10L 25/63; G10L 15/1815; G10L 15/197

(57) ABSTRACT

A spoken dialog system and methods of using the system is described. A method may comprise: receiving audible human speech from a user; determining textual speech data based on the audible human speech; extracting, from the audible human speech, signal speech data that is indicative of acoustic characteristics which correspond to the textual speech data; and using the textual speech data and the signal speech data, generating a response to the audible human speech.

### TECHNICAL FIELD

The present disclosure relates to computational methods and computer systems for understanding a human speech input and/or generating a response to it.

### BACKGROUND

Speech processing may use speech signals for front-end processing (e.g., for noise reduction or speech enhancement) and automatic speech recognition. Thereafter, the speech signals are then typically unused or discarded.

### SUMMARY

A spoken dialog system and methods of using the system is described. According to an embodiment, the method may comprise: receiving audible human speech from a user; determining textual speech data based on the audible human speech; extracting, from the audible human speech, signal speech data that is indicative of acoustic characteristics which correspond to the textual speech data; and using the textual speech data and the signal speech data, generating a response to the audible human speech.

According to one embodiment, a method of using a spoken dialog system is disclosed. The method may comprise: receiving audible human speech from a user; determining textual speech data based on the audible human speech; extracting, from the audible human speech, signal speech data that is indicative of acoustic characteristics which correspond to the textual speech data; based on the textual speech data, determining, using a natural language understanding model, a text string comprising an ambiguation, wherein the ambiguation comprises a first interpretation of the text string and a second interpretation of the text string, wherein the first interpretation differs from the second interpretation; determining the first interpretation is most accurate by corresponding word boundaries determined from the text string with the acoustic characteristics determined from the signal speech data; and generating a response to the audible human speech based on the first interpretation.

According to another embodiment, a non-transitory computer-readable medium comprising a plurality of computer-executable instructions and memory for maintaining the plurality of computer-executable instructions is disclosed. The computer-executable instructions when executed by one or more processors of a computer may perform the following functions: receive audible human speech from a user; determine textual speech data based on the audible human speech; extract, from the audible human speech, signal speech data that is indicative of acoustic characteristics which correspond to the textual speech data; based on the textual speech data, determine, using a natural language understanding model, a text string comprising an ambiguation, wherein the ambiguation comprises a first interpretation of the text string and a second interpretation of the text string, wherein the first interpretation differs from the second interpretation; determine the first interpretation is most accurate by corresponding word boundaries determined from the text string with the acoustic characteristics determined from the signal speech data; and generate a response to the audible human speech based on the first interpretation.

According to another embodiment, a method of response generation is disclosed. The method may comprise: receiving audible human speech from a user; determining textual speech data based on the audible human speech; extracting, from the audible human speech, signal speech data that is indicative of acoustic characteristics which correspond to the textual speech data; using a text-based sentiment analysis tool, determining that a sentiment analysis of the textual speech data is Positive or Neutral; using a signal-based sentiment analysis tool, determining that a sentiment analysis of the signal speech data is Negative; and based on the sentiment analyses of the textual and signal speech data, determining that the audible human speech comprises sarcasm.

According to the at least one example set forth above, a computing device comprising at least one processor and memory is disclosed that is programmed to execute any combination of the examples of the method(s) set forth herein.

According to the at least one example, a computer program product is disclosed that includes a computer readable medium that stores instructions which are executable by a computer processor, wherein the instructions of the computer program product include any combination of the examples of the method(s) set forth herein and/or any combination of the instructions executable by the one or more processors, as set forth herein.

### BRIEF DESCRIPTION OF THE DRAWINGS

FIG. 1 is a schematic diagram illustrating a spoken dialog system embodied in a table-top device.

FIG. 2 is a schematic diagram illustrating a hybrid architecture for the dialog system comprising an end-to-end dialog system and a task-specific dialog system.

FIG. 3 is a schematic diagram illustrating an architecture embodiment of the end-to-end dialog system shown in FIG. 2.

FIG. 4 is a flowchart illustrating an embodiment of a process of processing speech using the end-to-end dialog system of FIG. 3.

FIG. 5 is a schematic diagram illustrating an architecture embodiment of the task-specific dialog system shown in FIG. 2.

FIG. 6 is a flowchart illustrating an embodiment of a process of processing speech using the task-specific dialog system.

FIG. 7A is a flowchart illustrating an embodiment of a process of disambiguating speech.

FIG. 7B is a flowchart illustrating another embodiment of a process of disambiguating speech.

FIG. 8 is a flowchart illustrating yet another embodiment of a process of disambiguating speech.

FIG. 9 is a schematic diagram illustrating that the dialog system may be embodied in a kiosk.

FIG. 10 is a schematic diagram illustrating that the dialog system may be embodied in a mobile device.

FIG. 11 is a schematic diagram illustrating that the dialog system may be embodied in a vehicle.

FIG. 12 is a schematic diagram illustrating that the dialog system may be embodied in a robotic machine.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

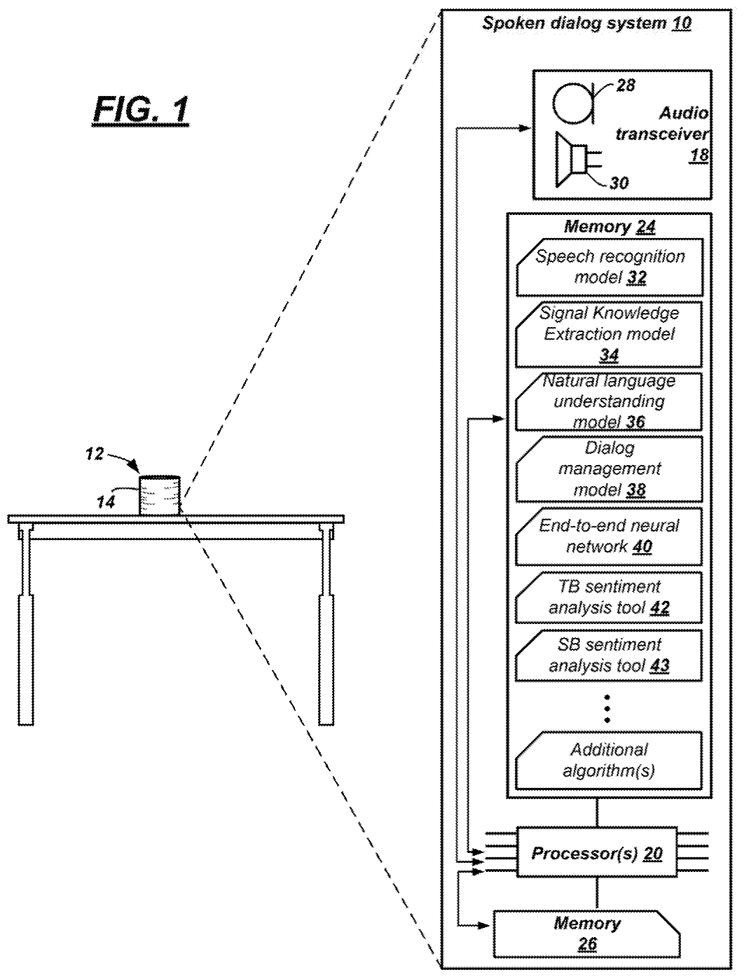

Turning now to the figures (e.g., FIG. 1), wherein like reference numerals indicate similar or identical features or functions, a spoken dialog system 10 is shown embodied in a table-top device 12 that receives an utterance (e.g., audible human speech from a user (not shown)) and based on the utterance, generates an appropriate speech response. Because the spoken dialog system 10 utilizes signal speech data and textual speech data, the dialog system 10 provides more accurate responses. Signal speech data may refer to speech that is indicative of acoustic characteristics which correspond to the textual speech data (e.g., pauses between words or sentences, emotion, emphasis, or the like). As discussed above, conventional speech systems typically do not use the signal speech data following front-end processing and automatic speech recognition. Dialog system 10 uses both textual speech data and signal speech data derived from the user's audible human speech to more fully understand the user's meaning. Accordingly, responses generated by the dialog system 10 (e.g., in response to the utterance) have a higher likelihood of being in context, especially where conventional systems may not identify sarcasm or may not accurately interpret ambiguity (e.g., arising from text-based only processing).

Table-top device 12 may comprise a housing 14 and the dialog system 10 may be carried by the housing 14. Housing 14 may be any suitable enclosure, which may or may not be sealed. And the term housing should be construed broadly. Table-top device 12 may be suitable for resting atop tables, shelves, or on floors and/or for attaching to walls, underneath counters, or ceilings, etc. according to any suitable orientation.

Spoken dialog system 10 may comprise an audio transceiver 18, one or more processors 20 (for purposes of illustration, only one is shown), any suitable quantity and arrangement of non-volatile memory 24 (storing one or more programs, algorithms, models, or the like) and/or any suitable quantity and arrangement of volatile memory 26. Accordingly, dialog system 10 comprises at least one computer (e.g., embodied as at least one of the processors 20 and memory 24, 26), wherein the dialog system 10 is configured to carry out the methods described herein. Each of the audio transceiver 18, processor(s) 20, memory 24, and memory 26 will be described in turn.

Audio transceiver 18 may comprise one or more microphones 28 (only one is shown), one or more loudspeakers 30 (only one is shown), and one or more electronic circuits (not shown) coupled to the microphone(s) 28 and/or loudspeaker(s) 30. The electronic circuit(s) may comprise an amplifier (e.g., to amplify an incoming and/or outgoing analog signal), a noise reduction circuit, an analog-to-digital converter (ADC), a digital-to-analog converter (DAC), and the like. Audio transceiver 18 may be coupled communicatively to the processor(s) 20 so that audible human speech may be received into the dialog system 10 and so that a generated response may be provided audibly to the user once the dialog system 10 has processed the user's speech.

Processor(s) 20 may be programmed to process and/or execute digital instructions to carry out at least some of the tasks described herein. Non-limiting examples of processor(s) 20 include one or more of a microprocessor, a microcontroller or controller, an application specific integrated circuit (ASIC), a field-programmable gate array (FPGA), one or more electrical circuits comprising discrete digital and/or analog electronic components arranged to perform predetermined tasks or instructions, etc. —just to name a few. In at least one example, processor(s) 20 read from non-volatile memory 24 and/or memory 26 and/or and execute multiple sets of instructions which may be embodied as a computer program product stored on a non-transitory computer-readable storage medium (e.g., such as non-volatile memory 24). Some non-limiting examples of instructions are described in the process(es) below and illustrated in the drawings. These and other instructions may be executed in any suitable sequence unless otherwise stated. The instructions and the example processes described below are merely embodiments and are not intended to be limiting.

Non-volatile memory 24 may comprise any non-transitory computer-usable or computer-readable medium, storage device, storage article, or the like that comprises persistent memory (e.g., not volatile). Non-limiting examples of non-volatile memory 24 include: read-only memory (ROM), erasable programmable read-only memory (EPROM), electrically erasable programmable read-only memory (EEPROM), optical disks, magnetic disks (e.g., such as hard disk drives, floppy disks, magnetic tape, etc.), solid-state memory (e.g., floating-gate metal-oxide semiconductor field-effect transistors (MOSFETs), flash memory (e.g., NAND flash, solid-state drives, etc.), and even some types of random-access memory (RAM) (e.g., such as ferroelectric RAM). According to one example, non-volatile memory 24 may store one or more sets of instructions which may be embodied as software, firmware, or other suitable programming instructions executable by the processor(s) 20—including but not limited to the instruction examples set forth herein. For example, according to an embodiment, non-volatile memory 24 may store various programs, algorithms, models, or the like.

Volatile memory 26 may comprise any non-transitory computer-usable or computer-readable medium, storage device, storage article, or the like that comprises nonpersistent memory (e.g., it may require power to maintain stored information). Non-limiting examples of volatile memory 26 include: general-purpose random-access memory (RAM), static RAM (SRAM), dynamic RAM (DRAM), or the like.

Herein, the term memory may refer to either non-volatile or volatile memory, unless otherwise stated. During operation, processor(s) 20 may read data from and/or write data to memory 24 or 26.

According to the illustrated example of FIG. 1, processor(s) 20 may execute a variety of programs stored in memory 24, including a speech recognition model 32 (that receives and recognizes audible human speech), a signal knowledge extraction model 34 (that determines acoustic characteristics based on the audible human speech—e.g., using its analog signal, a digital signal based on the analog signal, and/or electrical characteristics thereof), a natural language understanding model 36 (that interprets natural human speech), a dialog management model 38 (that determines, in part, an appropriate response to human speech, an end-to-end neural network 40 (that may be trained to determine an appropriate response to human speech comprising sarcasm), a text-based (TB) sentiment analysis tool 42 (that determines a human sentiment based on a textual analysis of human speech), a signal-based (SB) sentiment analysis tool 43 (that determines a human sentiment based on a signal analysis of human speech), other suitable algorithms, a combination thereof, or the like. According to an example, memory 24 may store any combination of the one or more of the above-cited programs and may not store others. Programs (32-43) each may comprise a unique of set instructions; and programs (32-43) are merely examples (e.g., one or more other programs may be used instead).

Speech recognition model 32 may be any suitable set of instructions that processes audible human speech; according to an example, speech recognition model 32 converts human speech into recognizable and/or interpretable words (e.g., textual speech data). A non-limiting example of the speech recognition model 32 is a model comprising an acoustic model, a pronunciation model, and a language model—e.g., wherein the acoustic model maps audio segments into phonemes, wherein the pronunciation model connects the phonemes together to form words, and wherein the language model expresses a likelihood of a given phrase. Continuing with the present example, speech recognition model 32 may, among other things, receive human speech via microphone(s) 28 and determine the uttered words and their context based on the textual speech data.

Signal knowledge extraction model 34 (shown in FIG. 1) may be any suitable set of instructions that extract signal speech data from a user's audible human speech and use the extracted signal speech data to clarify ambiguities that arise from analyzing the text without such signal speech data. Further, in some examples, the signal knowledge extraction model 34 may comprise instructions to identify sarcasm information in the audible human speech. Thus, the signal knowledge extraction model 34 facilitates a more accurate interpretation of the audible human speech; consequently, using information determined by the signal knowledge extraction model 34, dialog system 10 may generate more accurate responses.

According to at least one example, signal knowledge extraction model 34 uses raw audio (e.g., from the microphone 28) and/or the output of the speech recognition model 32. Signal speech data may comprise one or more of a prosodic cue, a spectral cue, or a contextual cue, wherein the prosodic cue comprises one or more of an accent feature, a stress feature, a rhythm feature, a tone feature, a pitch feature, and an intonation feature, wherein the spectral cue comprises any waveform outside of a range of frequencies assigned to an audio signal of a user's speech (e.g., spectral cues can be disassembled into its spectral components by Fourier analysis or Fourier transformation), wherein the contextual cue comprises an indication of speech context (e.g., circumstances around an event, statement, or idea expressed in human speech which provides additional meaning). Types of extracted signal knowledge (i.e., the signal speech data) will be discussed in detail below.

The natural language understanding model 36 may comprise a natural language unit (NLU) 44 (also called a natural language processor or NLP) and an utterance disambiguation unit 46 (see also FIG. 5). The NLU 44 may comprise any known computer algorithm enabling communication interactions between computers and human languages (e.g., utilizing linguistics science, computer science, information science, and/or artificial intelligence). The NLU 44 may be rule-based and/or statistical-based. Further, in its evaluations, the NLU 44 may utilize one or more of the following evaluations and/or tasks: syntax (e.g., grammar induction, lemmatization, morphological segmentation, part-of-speech tagging, parsing, sentence breaking, stemming, word segmentation, terminology extraction, etc.), semantics (lexical semantics, distributional semantics, machine translation, named-entity recognition, natural language generation, natural language understanding, optical character recognition, question answering, recognizing textual entailment, relationship extraction, sentiment analysis, topic segmentation and recognition, word sense disambiguation, etc.), discourse (automatic summarization, coreference resolution, discourse analysis, etc.), speech (speech recognition, speech segmentation, text-to-speech, etc.), or dialog. The natural language understanding model 36 may output one or more text strings (e.g., each in the form of a phrase, a sentence, or the like, wherein the text strings may have multiple understanding result—e.g., names, sarcasm or not, whether or not any word is emphasized, user intent, etc.).

Utterance disambiguation unit 46 may comprise one or more computer algorithms used to determine an interpretation (a.k.a., meaning) of an utterance. E.g., the NLU 44 may list the ambiguities (i.e., multiple possible interpretations) contained in the text string (e.g., sentences or partial sentences) uttered by the user, while the utterance disambiguation unit 46 may conduct disambiguation and pick the most likely interpretation as the natural language understanding result based on available speech/text knowledge. Illustrative algorithms of such disambiguation are discussed in greater detail below.

The natural language understanding model 36 may comprise the NLU 44 and the utterance disambiguation unit 46 as partitioned software (e.g., as shown, wherein the utterance disambiguation unit 46 is shown in phantom). Alternatively, the NLU 44 and utterance disambiguation unit 46 may be a single or integrated software unit.

Returning to FIG. 1, dialog management model (DMM) 38 may refer to an algorithm which determines how and whether to converse with the user. Receiving information from the natural language understanding model 36 and/or the signal knowledge extraction model 34, DMM 38 may employ text, speech, graphics, haptics, gestures, and other modes for communication. Among other things, DMM 38 may manage the state of a dialog between the dialog system 10 and the user, as well as a dialog strategy.

End-to-end neural network 40 may be any suitable neural network that is trained to generate a response using the user's input as the neural network input. It may have one or more layers (e.g., single, layered, recurrent without modularization, etc.). Non-limiting examples of the end-to-end neural network 40 include a conditional Wasserstein autoencoder (WAE), a conditional variational autoencoder (CVAE), or the like. According to at least one example, the neural network 40 may be programmed to generate an appropriate response according to whether or not sarcasm is detected in the audible human speech received by dialog system 10.

Text-based (TB) sentiment analysis tool 42 may be any software program, algorithm, or model which receives as input a word sequence (e.g., textual speech data from the speech recognition model 32) and classifies the word sequence according to a human emotion (or sentiment). While not required, the text-based sentiment analysis tool 42 may use machine learning (e.g., such as a Python™ product) to achieve this classification. The resolution of the classification may be Positive, Neutral, or Negative in some examples; in other examples, the resolution may be binary (Positive or Negative), or tool 42 may have increased resolution, e.g., such as: Very Positive, Positive, Neutral, Negative, and Very Negative (or the like). One non-limiting example is Python's™ NLTK Text Classification; however, this is merely an example, and other examples exist.

Signal-based (SB) sentiment analysis tool 43 may be any software program, algorithm, or model which receives as input acoustic characteristics derived from the signal speech data (e.g., from the signal knowledge extraction model 34) and classifies the acoustic characteristics according to a human emotion (or sentiment). While not required, the signal-based sentiment analysis tool 43 may use machine learning (e.g., such as a Python™ product) to achieve this classification. The resolution of the classification may be Positive, Neutral, or Negative in some examples; in others, the resolution may be binary (Positive or Negative), or tool 43 may have increased resolution, e.g., such as: Very Positive, Positive, Neutral, Negative, and Very Negative (or the like). One non-limiting example is the Watson Tone Analyzer by IBM™; this is merely an example, and other examples exist.

It will be appreciated that computer programs, algorithms, models, or the like may be embodied in any suitable instruction arrangement. E.g., one or more of the speech recognition model 32, the signal knowledge extraction model 34, the natural language understanding model 36, the dialog management model 38, the end-to-end neural network 40, and any other additional suitable programs, algorithms, or models may be arranged as a single software program, multiple software programs capable of interacting and exchanging data with one another via processor(s) 20, etc. Further, any combination of the above programs, algorithms, or models may be stored wholly or in part on memory 24, memory 26, or a combination thereof.

Turning now to FIG. 2, a schematic diagram illustrating a hybrid architecture 50 for the dialog system 10 is shown, the hybrid architecture 50 comprising an end-to-end dialog system 52, a task-specific dialog system 54, additional data 56 (e.g., user knowledge, dialog context, external knowledgebase, common sense knowledge), a ranking of preliminary responses 58, and a determination of a final response 60 based on the ranking 58. All elements of the architecture 50 may be executed by processor(s) 20 and/or at least partially stored on memory 24, 26. More particularly, FIG. 2 illustrates that audible human speech from a user may be received at both system 52 and system 54. FIG. 2 further illustrates the ranking of preliminary responses 58 may be based on: a (preliminary) response P1 of the end-to-end dialog system 52, a preliminary response P2 of the task-specific dialog system 54 (which may differ from that of system 52), and additional relevant data 56 (e.g., user data, context data, external data, etc.). Further, the architecture 50 illustrates that a ranked selection may be provided, from the ranking 58, to the determination of the final response 60.

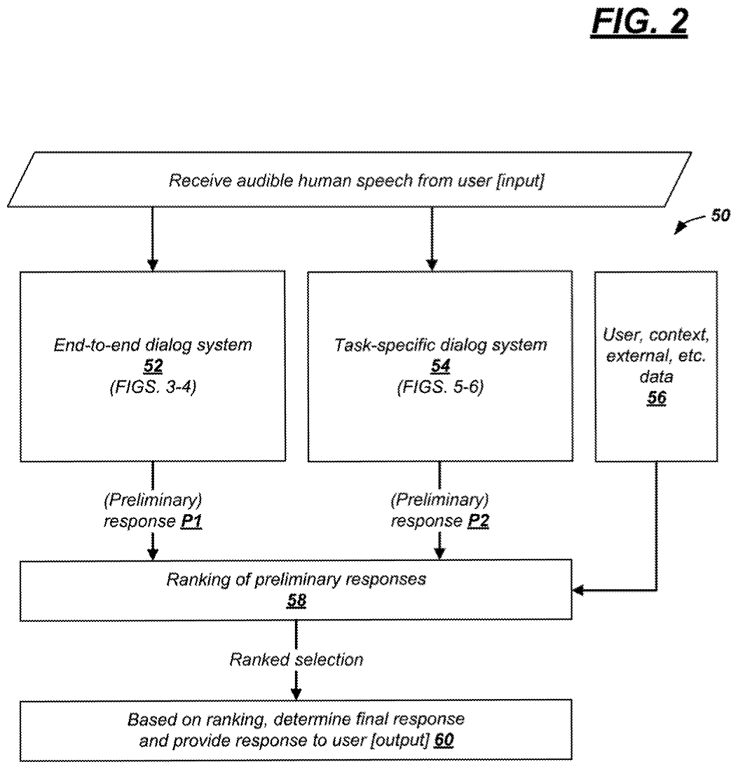

According to the illustrated example of FIG. 3, end-to-end dialog system 52 may be configured to identify and interpret sarcasm information, as well as identify and/or interpret emphasis information and/or emotion information from a user's audible human speech. More particularly, audible human speech may be an input to both the speech recognition model 32 and the signal knowledge extraction model 34. And the speech recognition model 32 may provide an output to both the signal knowledge extraction model 34 and the neural network 40 which generates the (preliminary) response P1 (or output) of the end-to-end dialog system 52. When present in a user's speech, sarcasm information may add sharpness, irony, and/or satire; sarcasm information may be witty, bitter, or the like and may or may not be directed at an individual or other speaker. Further, in some instances, sarcasm information may infer that the user means the opposite of what he/she has uttered. Exemplary operation of the neural network 40 (and its input and output) is described below. FIG. 3 also illustrates that the signal knowledge extraction model 34 may provide an output to the end-to-end neural network 40 (e.g., sarcasm information, emphasis information, emotion information, or the like). Additionally, in some examples, neural network 40 may generate a (preliminary) response at least partially based on additional data 56. Non-limiting examples of additional data 56 include: user data (e.g., the user's age, demographics, likes/dislikes, speech habits, attitudes, etc.), context data (e.g., dialog history), and/or external data (e.g., data regarding a time of the audible human speech, data regarding a location of the audible human speech, or both).

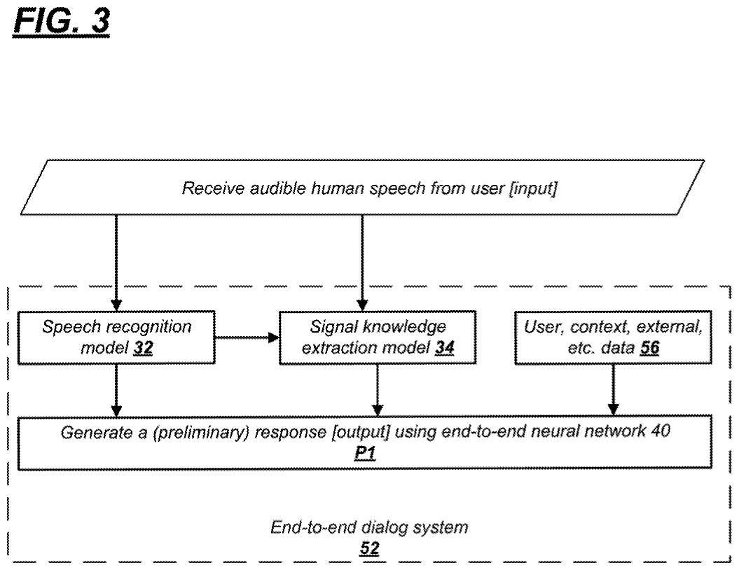

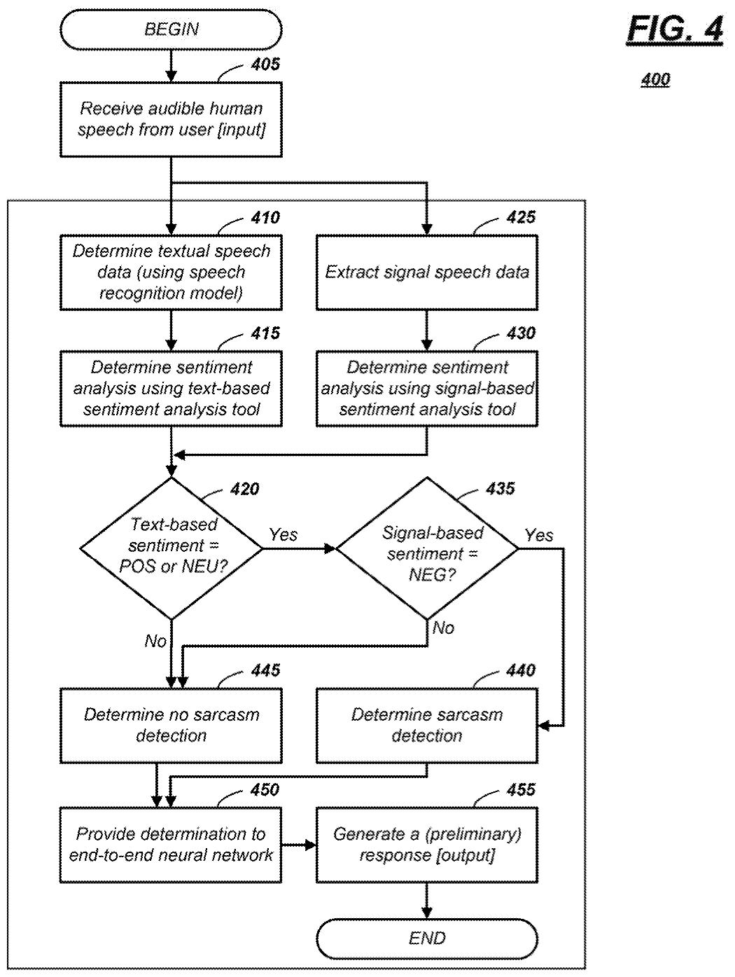

FIG. 4 is a flowchart illustrating an embodiment of a process 400 of processing speech using the end-to-end dialog system 52. Process 400 is illustrated with a plurality of instructional blocks which may be executed by the one or more processors 20 of dialog system 10. The blocks may be executed in any suitable order, unless otherwise set forth herein. The process may begin with block 405.

In block 405, processor(s) 20 may receive an utterance (e.g., audible human speech as an input to the dialog system 10). E.g., this may be received using audio transceiver 18 and provided to processor(s) 20 so that dialog system 10 may provide an appropriate response.

Blocks 410 and 425 may follow. In block 410, the speech recognition model 32 may determine textual speech data based on the audible human speech. For example, speech recognition model 32 may determine a sequence of words representative of the user's speech.

In block 415 which may follow block 410, text-based sentiment analysis tool 42 may receive the sequence of words and determine a sentiment value regarding the textual speech data. It will be appreciated that outputs of the text-based sentiment analysis tool 42 may be categorized by degree (e.g., three degrees, such as: positive, negative, or neutral). Once the sentiment value is determined in block 415, process 400 may proceed to block 420.

In block 420, processor(s) 20 determine whether the sentiment value of the textual speech data is ‘Positive’ (POS) or ‘Neutral’ (NEU). If the textual speech data is determined to be ‘Positive’ or ‘Neutral,’ then process 400 proceeds to block 435. Else (e.g., if it is ‘Negative’), the process proceeds to block 445.

In at least one example, block 425 occurs at least partially concurrently with block 410. In block 425, processor(s) 20 may extract signal speech data from the audible human speech received in block 405. As discussed above, the signal speech data may be indicative of acoustic characteristics which include pause information corresponding to the textual speech information (e.g., non-limiting examples include: one or more pause locations in the signal speech data, wherein the one or more pause locations correspond with beginnings and endings of words, phrases, or sentences; pause durations corresponding to the one or more pause locations; one or more vocal inflections; one or more vocal amplitude signals, one or more speech emphases; one or more speech inflections; other speech-related sounds; one or more signal amplitudes; one or more signal frequencies; one or more changes in signal amplitude and/or signal frequency; one or more patterns; one or more signatures; and/or the like).

In block 430 which may follow block 425, signal-based sentiment analysis tool 43 may receive signal speech data comprising analog and/or digital data and determine a sentiment value regarding the signal speech data. It will be appreciated that outputs of the signal-based sentiment analysis tool 43 also may be categorized by degree (e.g., three degrees, such as: positive, negative, or neutral). Once the sentiment value of the instant signal speech data is determined, process 400 may proceed to block 420 (previously described above).

In block 435 which may follow block 420, processor(s) 20 determine whether the sentiment value from the signal-based sentiment analysis tool 43 is ‘Negative.’ If the respective sentiment value is ‘Negative,’ then process 400 proceeds to block 440. Else (e.g., if the respective sentiment value of the signal-based sentiment analysis tool 43 is ‘Positive’ or ‘Neutral’), the process 400 proceeds to block 445.

In block 440, processor(s) 20 determine sarcasm detection—e.g., that the audible human speech comprises sarcasm expressed by the user—based on both the textual-based and the signal-based sentiment values of the output of the speech recognition model 32 and the signal knowledge extraction model 34, respectively. This detection may refer to the processor(s) 20 determining that sarcasm is more likely than a (predetermined or determined) threshold to comprise sarcasm. Whether the threshold is predetermined or not may be based on user, context, and/or external data 56. For example, if adequate user, context, and/or external data 56 is available prior to executing process 400, then the threshold may be predetermined. Or for example, if inadequate user, context, and/or external data 56 is available prior to executing process 400, then the threshold may not be predetermined (e.g., may be determined during execution of process 400 or the like). In either case, other examples also exist. Following block 440, the process may proceed to block 450.

In block 445 (which may follow block 420 or block 435), processor(s) 20 determine that no sarcasm has been detected—e.g., that the audible human speech does not comprise sarcasm expressed by the user. This detection may refer to the processor(s) 20 determining that sarcasm is less likely than a predetermined threshold or a determined threshold to comprise sarcasm (e.g., similar to the discussion above). Following block 445, the process may proceed to block 450.

In block 450, the determination (sarcasm or no sarcasm) may be provided to end-to-end neural network 40. According to an example, an input of the neural network 40 may comprise a dialog between the user and the dialog system 10—e.g., one or more sentences uttered by the user intersticed with one or more responses from the dialog system 10 (e.g., according to one example, the input to the neural network 40 comprises at least two user utterances and may further comprise a previous response to one of the user's previous utterances). In this example, when sarcasm is determined (e.g., per block 440), then the utterance of the user may comprise an embedding vector indicative of sarcasm, and the input to the neural network 40 further may comprise a one-hot vector (0/1) comprising at least one dimension indicating sarcasm (e.g., a ‘1’). When sarcasm is not determined (e.g., per block 445), then the utterance of the user may comprise no embedding vector (or a zero vector), and the input to the neural network 40 further may comprise the one-hot vector (0/1) comprising at least one dimension indicating sarcasm (e.g., continuing with the example, here a ‘0’). In this manner, the end-to-end neural network 40 may process an input and generate an appropriate output in block 455.

Block 455, which follows, may comprise dialog system 10 generating a (preliminary) response (output) to the audible human utterance, which may include acknowledgement of the user's sarcasm or not. As described more below, in one example, this response is preliminary—e.g., in the hybrid architecture 50, the dialog system 10 also may evaluate an output of the task-specific dialog system 54 before determining a final output. In other examples, the end-to-end dialog system 52 may be executed independently from a remainder of the hybrid architecture 50; in this latter example, the output at block 455 may be a final output (e.g., no further processing of the audible human speech will occur). Regardless of whether the response in block 455 is preliminary, following block 455, the process 400 may end.

The following illustration is merely an example of appropriate inputs and outputs to dialog system 10, wherein the generated response acknowledges the user's sarcasm (when it is present). Consider the dialog system 10 inquiring: How are you doing today? The user might respond by stating: I'm having a great day when, in fact, the user sarcastically means s/he is not having a great day. Without determining sarcasm according to process 400, the user may become irritated if dialog system 10 replied: I'm glad to hear you're having a great day! Instead, it is desirable that the dialog system 10 detects the sarcasm (in I'm having a great day) and provides an appropriate response, such as: Oh, I'm sorry. What's wrong? The dialog system 10 is configured to improve computer response to user sarcasm.

Returning to FIG. 2, recall that hybrid architecture 50 further could comprise the task-specific dialog system 54. As shown in FIG. 5, task-specific dialog system 54 may be configured to identify and interpret, among other things, ambiguous words, phrases, and/or sentences. FIG. 5 illustrates that audible human speech is received by the speech recognition model 32 and the signal knowledge extraction model 34. Further, the speech recognition model 32 may provide an output to both the signal knowledge extraction model 34 and the natural language understanding model 36. As illustrated (and briefly discussed above), natural language understanding model 36 may comprise the NLU 44 and the utterance disambiguation unit 46, wherein utterance disambiguation unit 46 may determine whether ambiguity exists in a word sequence (received from the speech recognition model 32) and may resolve determined ambiguities by interacting with the signal knowledge extraction model 34.

The natural language understanding model 36 may provide an output (e.g., one or more text strings that represent the understanding result for the input speech) to the dialog management model (DMM) 38. For example, as illustrated in FIG. 5, NLU 44 may provide the output to DMM 38 via a decision 66, or alternatively, the utterance disambiguation unit 46 may provide the output via decision 66. Decision 66 may determine whether an ambiguation exists in the output of the NLU 44. When such ambiguation is absent, NLU 44 may provide the output, and when such ambiguation is determined at decision 66, then an ambiguation resolution model 68 may provide the output to DMM 38. Here, decision 66 is illustrated as part of the utterance disambiguation unit 46; however, this is not required. In other examples, it may be part of the NLU 44 or a unit separate from NLU 44 and utterance disambiguation unit 46. Decision 66 may be any suitable set of instructions embodied as a program, algorithm, or model.

Ambiguation resolution model 68 may execute two-way communication with the signal knowledge extraction model 34—e.g., before providing the output to the DMM 38. For example, signal knowledge extraction model 34 may provide signal speech data regarding the ambiguity, thereby enabling ambiguation resolution model 68 to determine a meaning of the ambiguity with increased accuracy.

According to FIG. 5, the DMM 38 may receive output from the natural language understanding model 36, the signal knowledge extraction model 34 (e.g., emphasis information, emotion information, or the like), and/or additional data 56 (user, context, external, etc. data). Based on these inputs, DMM 38 (as described more below in process 600) may determine (e.g., generate) a (preliminary) response (output) P2.

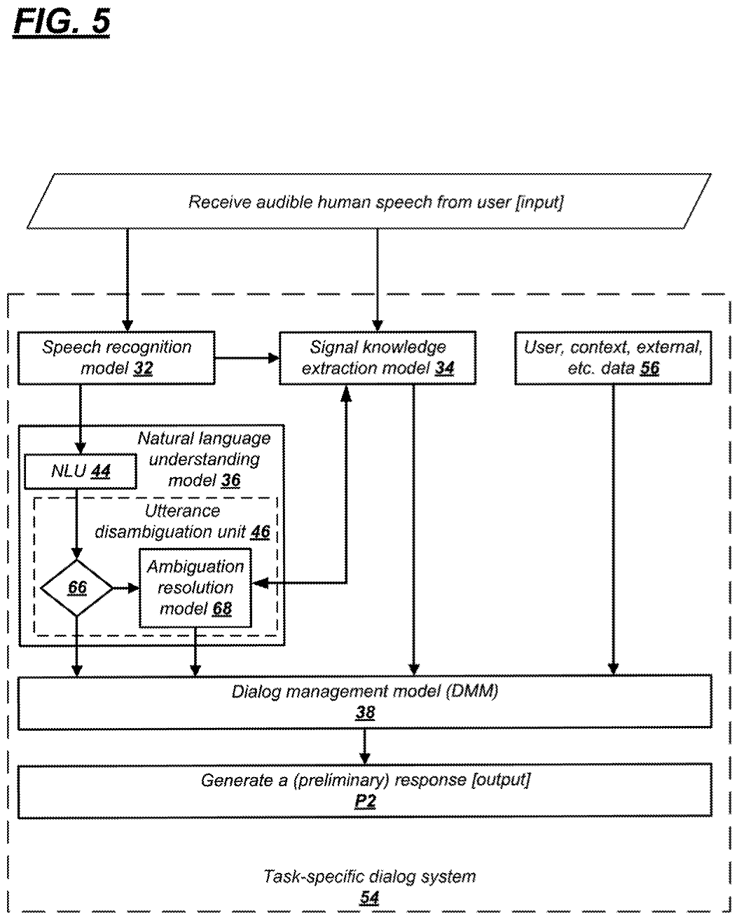

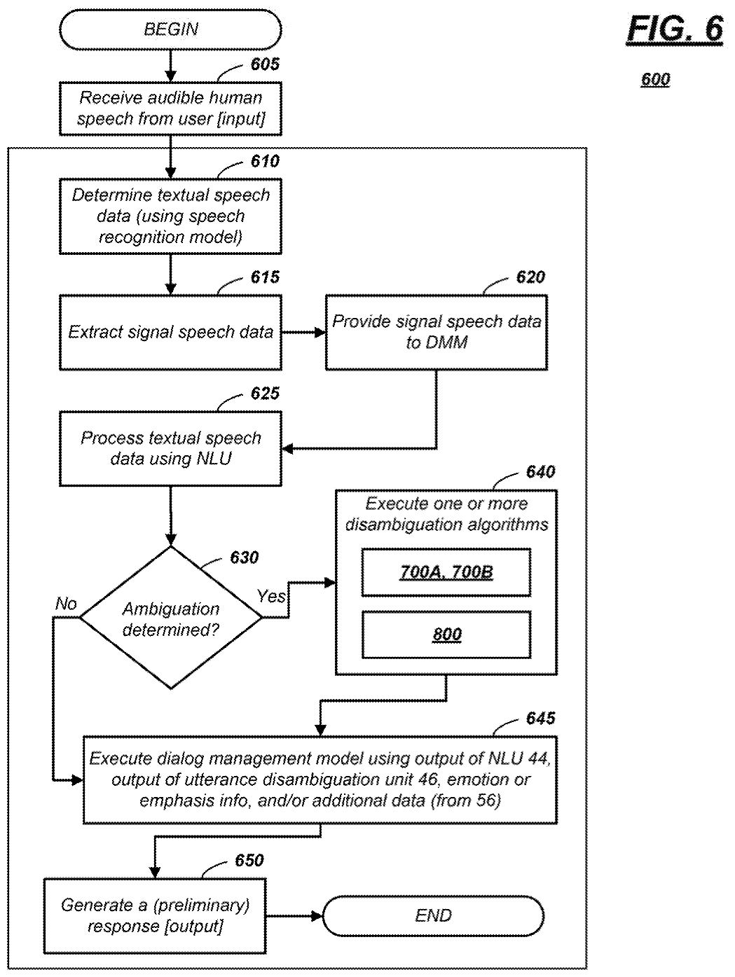

FIG. 6 is a flowchart illustrating an embodiment of a process 600 describing an example technique of processing speech using the task-specific dialog system 52. Process 600 is illustrated with a plurality of instructional blocks which may be executed by the one or more processors 20 of dialog system 10. The process may begin with block 605.

In block 605, processor(s) 20 may receive an utterance (e.g., audible human speech as an input to the dialog system 10). E.g., this may be received using audio transceiver 18 and provided to processor(s) 20 so that dialog system 10 may provide an appropriate response. According to at least one embodiment, this is the same audible human speech received in process 400.

Block 610 may follow. In block 610, the speech recognition model 32 may determine textual speech data based on the audible human speech. For example, speech recognition model 32 may determine a sequence of words representative of the user's speech.

Following block 610, processor(s) 20 may execute block 615. Blocks 610 and 615 may occur at least partially concurrently. In block 615, processor(s) 20 may extract signal speech data from the audible human speech received in block 605. As discussed above, the signal speech data may be indicative of acoustic characteristics which include pause information corresponding to the textual speech information (e.g., non-limiting examples include: one or more pause locations in the signal speech data, wherein the one or more pause locations correspond with beginnings and endings of words, phrases, or sentences; pause durations corresponding to the one or more pause locations; one or more vocal inflections; one or more vocal amplitude signals, one or more speech emphases; one or more speech inflections; other speech-related sounds; one or more signal amplitudes; one or more signal frequencies; one or more changes in signal amplitude and/or signal frequency; one or more patterns; one or more signatures; and/or the like). Further, the signal speech data may be indicative of other acoustic characteristics such as emotion information, other emphasis information, etc.

According to one example, blocks 405 and 605 may be identical, blocks 410 and 610 may be identical, and blocks 425 and 615 may be identical. According to an example wherein both the end-to-end and task-specific dialog systems 52, 54 are being executed, processor(s) 20: may execute instruction 405 and the execution and output of block 405 is shared with block 605; thereby executing only one of block 405 or block 605); may execute instruction 410 and the execution and output of block 410 is shared with block 610; thereby executing only one of block 410 or block 610); and may execute instruction 425 and the execution and output of block 425 is shared with block 615; thereby executing only one of block 425 or block 615). In this manner, computational efficiency is promoted in the dialog system 10.

In block 620 which may follow block 615, processor(s) 20 may provide the signal speech data to the DMM 38.

In block 625 which may follow, processor(s) 20 may process textual speech data using NLU 44 and output a text string. Block 625 may occur any time following block 610. Here, the NLU 44 may generate at least one meaning or interpretation of the textual speech data. In some instances, the NLU 44 may generate more than one meaning or interpretation of the textual speech data. And the NLU 44 (or decision 66) may generate or determine the existence of multiple meanings or interpretations of a phrase or sentence (determined using NLU 44).

In block 630 which follows, the processor(s) 20 determine whether an ambiguation exists. E.g., when the NLU 44 or the utterance disambiguation unit 46 determines such an ambiguation, then process 600 proceeds to block 640; else, process 600 may proceed to block 645.

According to an example of block 630, decision 66 provides the output of NLU 44 to ambiguation resolution model 68 which, in turn, provides the ambiguation to signal knowledge extraction model 34. According to at least one example (and as described in detail below), signal knowledge extraction model 34 may determine an interpretation of the text string by corresponding word boundaries of the text string with the acoustic characteristics determined from the signal speech data. Thereafter, signal knowledge extraction model 34 may provide its determination back to the ambiguation resolution model 68 (this may include multiple interpretations based on the word boundaries). With this interpretation data received from signal knowledge extraction model 34, ambiguation resolution model 68 may determine which interpretation is most accurate (e.g., which is more accurate than a threshold).

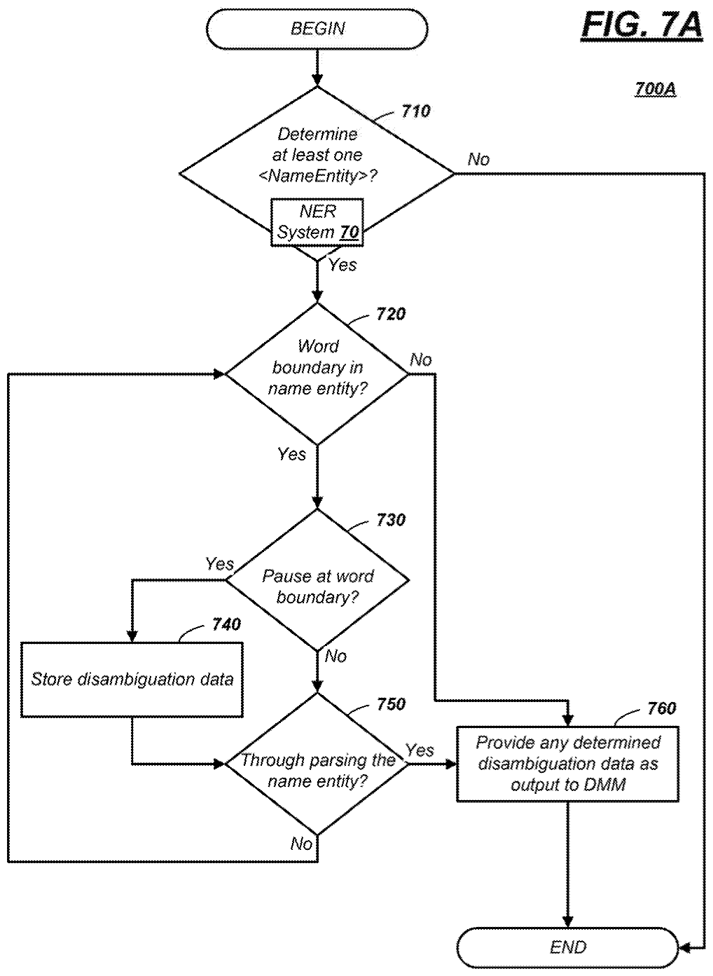

According to block 640, processor(s) 20 may execute one or more disambiguation algorithms. These may be embodied in at least one of processes 700A (FIG. 7A), 700B (FIG. 7B), 800 (FIG. 8), or another suitable algorithm. Examples of processes 700A, 700B, and 800 are discussed below. Following block 640, process 600 may proceed to block 645.

In block 645, accounting for the output of NLU 44, the output of utterance disambiguation unit 46, emotion or emphasis information (from signal knowledge extraction model 34), and/or additional data 56 (e.g., user, context, and/or external knowledge data), DMM 38 may determine an appropriate output that accounts for the potential ambiguation. In at least one example, the determined response may be a query to the user for more information (e.g., DMM 38 may need more information to determine an appropriate response). In other examples, the response may be a suitable answer to a question. In still other examples, it may be an otherwise appropriate response.

Block 650 may follow block 645. In block 650, dialog system 10 may generate a (preliminary) response (output) to the audible human utterance, which may account for the potential ambiguation, and this response may be provided to the user via audio transceiver 18 (e.g., via loudspeaker 30).

As described more below, in one example, this response is preliminary—e.g., in the hybrid architecture 50, the dialog system 10 also may evaluate the output of the end-to-end dialog system 52 before determining a final output. In other examples, the task-specific dialog system 54 may be executed independently from the remainder of the hybrid architecture 50; in this latter example, the output at block 650 may be a final output (e.g., no further processing of the audible human speech will occur). Regardless of whether the response in block 650 is preliminary, following block 650, the process 600 may end.

The following illustration is merely an example of appropriate inputs and outputs to dialog system 10, wherein the generated response accounts for an ambiguation (when it is present). For explanation purposes only, a pause having at least a threshold duration is designated as “< >.” Consider the dialog system 10 receiving the audible human speech, stating: I want to eat a banana muffin and cookies. Dialog system 10 could determine a first interpretation as: I want to eat a banana muffin < > and cookies. E.g., this could mean that banana modifies muffin (i.e., a type of muffin: a banana muffin). Alternatively, dialog system 10 could determine a second interpretation as: I want to eat a banana < > muffin < > and cookies. E.g., this could mean three separate items are desirable to eat: a banana, a muffin, and a cookie. The textual speech data (i.e., an output of speech recognition model 32) may determine the text (I want to eat a banana muffin and cookies), but it may not be able to discern the appropriate interpretation. Herein and within the recited claims, the terms first interpretation, second interpretation, etc. are designated first, second, etc. to distinguish one interpretation from another; these identifiers do not necessarily refer to an order of interpretation operation, nor do they necessarily refer specifically to the first and second interpretation examples set forth below, nor do they foreclose that any of the values of the first, second, etc. interpretations could not, in some circumstances, be similar or the same. Other factors may be evaluated by the dialog system 10 (e.g., including the signal speech data) to determine an accurate and appropriate interpretation. Algorithms shown in FIGS. 7A, 7B, and 8 are a few examples that may be executed (as part of process 600) to determine an accurate interpretation of ambiguous speech.

An example process 700A of speech disambiguation (FIG. 7A) follows. For example, process 700A may be used to determine an appropriate interpretation of a text string in task-specific dialog system 54. More particularly, process 700A may be useful in disambiguating noun-words/phrases which are adjacently located within the textual speech data (e.g., such as . . . banana muffin . . . , as illustrated above). Process 700A is illustrated with a plurality of instructional blocks which may be executed by the one or more processors 20 of dialog system 10. The blocks may be executed in any suitable order, unless otherwise set forth herein. The process may begin with block 710.

In block 710 (which may follow block 630 (FIG. 6)), processor(s) 20 may determine a name entity (<NameEntity>) within the speech processed by the NLU 44 using a name entity recognition (NER) system 70. The NER system 70 may be an algorithm that executes information extraction by locating and/or classifying text into pre-determined categories (e.g., such as person names, organizations, locations, time expressions, quantities, monetary values, percentages, and the like). When a name entity is determined, process 700A proceeds to block 720; else process 700A may end.

Consider the aforementioned example described in process 600: I want to eat a banana muffin and cookies. Two example interpretations follow.

Interpretation (1), wherein “I,” “banana muffin,” and “cookie” may be characterized as name entities.

[I]ₚₑᵣₛₒₙ want to eat a [banana muffin]_{food type} and [cookie]_{food type}.

Interpretation (2), wherein “I,” “banana,” “muffin,” and “cookie” may be characterized as name entities.

[I]ₚₑᵣₛₒₙ want to eat a [banana]_{food type} [muffin]_{food type} and [cookie]_{food type}.

Block 720 may follow block 710. In block 720, processor(s) 20 may identify whether a word boundary exists within a name entity. A word boundary may define a separation between two textual words—e.g., between an end of the first word and an end of a subsequent word. Thus, where name entities each comprise a single word—as in Interpretation (2)—no word boundary within the name entity will be identified. However, a word boundary does exist in Interpretation (1)—e.g., namely, in this example (comprising name entity <banana muffin>), the word boundary exists between the words banana and muffin. Thus, in block 720, if no word boundaries are determined within the name entity, then process 700A may proceed to block 760. If at least one word boundary is determined, then process 700A may proceed to block 730.

In block 730, processor(s) 20 may determine whether a pause exists at the word boundary using the signal speech data. For example, recall that signal speech data may comprise acoustic characteristics—e.g., block 730 may comprise determining whether a pause of a threshold duration occurs. Thus, the word boundary may be correlated to the signal speech data to evaluate whether such a pause exists. In at least one example, a known pause detection algorithm may be used in process 700A. And for example, if a pause (e.g., of a threshold duration) occurs at the word boundary, then process 700A may proceed to block 740; otherwise, process 700A may proceed to block 750.

In block 740, the pause associated with the word boundary may be stored (at least temporarily) as disambiguation data (e.g., until the process is complete). Following block 740, the process 700A may proceed to block 750.

In block 750, processor(s) 20 may determine whether the name entity has been fully parsed. For example, is all word boundaries have been analyzed for a threshold pause, then the process may proceed to block 760. Else, the process may loop back to block 720 and determine if additional word boundaries exist (e.g., which have not yet been evaluated).

Ultimately, via block 720 or block 750, process 700A may proceed to block 760. In block 760, processor(s) 20 may provide any disambiguation data as output to the DMM 38 (e.g., according to block 645 of FIG. 6). Thereafter, the process may end.

An example process 700B of speech disambiguation (FIG. 7B) follows. For example, process 700B may be used to determine an appropriate interpretation of a text string in task-specific dialog system 54. Process 700B is illustrated with a plurality of instructional blocks which may be executed by the one or more processors 20 of dialog system 10. The blocks may be executed in any suitable order, unless otherwise set forth herein.

According to at least the illustrated example, FIG. 7B comprises block 710′ and blocks 720, 730, 740, 750, and 760, wherein blocks 720, 730, 740, 750, and 760 (and their respective arrangement) may be similar or identical to those previously described. Therefore, for sake of brevity, only block 710′ will be described, and it will be appreciated that the remainder of process 700B may operate similarly as process 700A.

Block 710′ may comprise processor(s) 20 determining whether at least one <NameEntity> having predetermined criteria exists. When a name entity having predetermined criteria is determined, process 700B proceeds to block 720; else process 700B may end.

According to an example, NER system 70 may label words in the textual speech data as O (not a NameEntity), B-<NameEntityType> (a first word in a NameEntity of the type NameEntityType, e.g., the word “banana” in the NameEntity “banana muffin” whose NameEntityType is “Food”), and I-<NameEntityType> (a word following the first word in a NameEntity—e.g., not necessarily a second word but another word in the name entity that is not the first word—of the type NameEntityType). Furthermore, in addition to predicting a label as the NER result, the NER system 70 may output a list of possible labels for each word in the textual speech data and assign a probability for each of the labels in that list to indicate the likelihood of that label being accurate. For example, processor(s) 20 may generate a list of possible labels for a word, ranked by the label probabilities each of which ranges between 0 and 100%, and the top-ranked label (i.e., O, B-<NameEntityType>, or I-<NameEntityType>) is used as the NER result for the word in focus. The list of labels together with the corresponding probabilities for each word in the name entities detected in the NER result (e.g., in NER result of the sentence “I'd like to eat banana muffin and some cookies”, the words “banana”, “muffin” and “and” may be labeled as B-<Food>, I-<Food> and O respectively. So, the detected name entity in this example is “banana muffin”, a Food name.) is used in the name entity disambiguation procedure described in the following paragraph.

According to one non-limiting example, processor(s) 20 determine whether each name entity in the NER result is ambiguous and conduct disambiguation if an ambiguity exists. If the detected name entity only contains one word (e.g., “cookies” as a type of food), no ambiguous exists. If the detected name entity contains multiple words (e.g., “banana muffin”), ambiguity exists (e.g., the user may actually mean “banana” and “muffin”). One method for disambiguation is to check each boundary between every two connected words in the name entity in focus. For each boundary in focus, a classifier based on speech signals and speech recognition result is used to determine whether there is a pause at that boundary. If one or more pauses is detected, the name entity in focused is separated into multiple name entities of the same name entity type (e.g., if a pause is detected between “banana” and “muffin”, the name entity “banana muffin” will be separated into two Food name entities “banana” and “muffin”.), which are output as the disambiguation result. Otherwise, if no pauses are detected, the original name entity is kept and used as the disambiguation result. Another method for disambiguation is to selectively check the word boundaries within each multi-word name entity. For each word boundary in focus, if the list of labels for the next word (e.g., “muffin”) contains B-<NameEntityType> with a probability that is between a first threshold (e.g., 13%) and a second threshold (e.g., <97%), or contains I-<NameEntityType> with a probability that is between a third threshold (e.g., <13%) and a fourth threshold (e.g., <97%), the NER is judged as uncertain about whether a new name should start or whether the previous name should continue. Such word boundaries are then selected for the disambiguation processing in the similar way of the method 700A, i.e., first determining whether there is a pause in signals using the classifier for each selected boundary, and then determining whether the name entity should be separated into multiple name entities based on the detected pauses. Compared with the method 700A, method 700B may improve computer processing efficiency by not evaluating word boundaries where the NER system is confident about its predictions (i.e., either being or not being a B/I-<NameEntityType>) and thus may be less likely to contribute to determining disambiguation.

As described above, following block 710′, the process 700B may proceed similarly to that described in process 700A. Ultimately, process 700B may end—e.g., after providing any disambiguation data as output to the DMM 38 (e.g., according to block 645 of FIG. 6).

Turning now to FIG. 8, a flowchart is shown illustrating an example process 800 of speech disambiguation. Similar to processes 700A and 700B, process 800 may be used to determine an appropriate interpretation of a text string in task-specific dialog system 54. However, more particularly, process 800 may be useful in disambiguating other parsed words—e.g., not necessarily name entities. Process 800 is illustrated with a plurality of instructional blocks which may be executed by the one or more processors 20 of dialog system 10. The blocks may be executed in any suitable order, unless otherwise set forth herein. Before describing the instructions of process 800, an ambiguation example is provided so that it may be used to describe the process.

Consider textual speech data from the NLU 44 being: I will move on this Saturday. Recall that block 630 of process 600 (FIG. 6) may determine this textual statement to be an ambiguation. Consider the following example interpretations (using additional punctuation to illustrate emphasis and meaning which otherwise may be ambiguous at the output of NLU 44).

Interpretation (1), wherein the person will move on {e.g., to a new task} this Saturday.

I will move on . . . this Saturday.

Interpretation (2), wherein the person will move on {an upcoming date} Saturday.

I will move . . . on this Saturday.

Process 800 utilizes word boundaries as well; however, as described below, process 800 utilizes a chunking analysis and a binary prediction.

The process may begin with block 810, wherein processor(s) 20 analyze the processed speech of NLU 44 (text) using a chunking analysis (also called shallow or light parsing) and a predefined set of linguistic rules (e.g., whether a preposition word occurs immediately after a verb and before a noun phrase). As will be appreciated by skilled artisans, a chunking analysis may identify constituent parts (e.g., nouns, verbs, adjectives, etc.) of the speech processed by NLU 44 (e.g., which may be a sentence) and then link the constituent parts to higher order units that have discrete grammatical meanings (e.g., noun groups or phrases). Continuing with the example above, block 810 may determine a subject of the sentence (I), a verb (will move), and a noun (Saturday), wherein the chunking analysis may determine that “Saturday” is part of a prepositional phrase (on this Saturday).

Block 810 further may comprise identifying a first word boundary and a second word boundary. Continuing with the example above, block 810 may identify that a meaning of the sentence may depend on whether a relative separation (which may be expressed in speech in various ways, e.g., as a pause, as a change of speaking speed, etc.) exists between on and this (Interpretation (1)), or between move and on (Interpretation (2)). Accordingly, processor(s) 20 may identify the first word boundary to be between on and this and identify the second word boundary to be between move and on.

Block 820 may follow, wherein processor(s) 20 analyze the first and second word boundaries using a classification algorithm. For example, processor(s) 20 may determine at which of the two word boundaries a relative separation is located using signal speech data (e.g., using the signal knowledge extraction model 34). According to an example, the classification algorithm may be a binary prediction—e.g., implemented as a support vector machine (SVM) that is trained with a plurality of features extracted from the signal speech data. According to one example, one or more of 34 different features may be extracted and analyzed to determine whether a relative separation (which alters the meaning) exists at the first word boundary or the second word boundary. A non-limiting example of features are described below.

The features may be categorized as a feature set A (27 features), a feature set B (6 features), and a feature set C (1 feature). Some of the features refer to a focused position—a focused position may mean or refer to a position that is a boundary between two connected words in a speech sentence.

Feature set A may comprise 9 items, wherein processor(s) 20 may calculate a value for each checking position as a feature and calculate the difference of the value between the two checking positions as additional feature. Thus, there may be 9*3 or 27 features in feature set A.

| | |
|---|---|
| 1 | The duration of pause of the focused position, i.e., between the |
| | previous and subsequent words. Duration may be measured in |
| | seconds. |
| 2 | The duration of the last phone of the previous word of the |
| | focused position. |
| 3 | The duration of the previous word of the focused position. |
| 4 | The number of syllables in the previous word of the focused |
| | position. |
| 5 | The speech rate of the previous word of the focused position, |
| | defined as the number of syllables/the duration of the word. |
| 6 | The sum of the duration of the previous word and the duration |
| | of the pause of the focused position. |
| 7 | The sum of the duration of the last phone of the previous word |
| | and the duration of the pause for the focused position. |
| 8 | The difference between the duration of the last phone of the |
| | previous word of the focused position and the average duration |
| | of the same phone at the end of words, computed from WSJ |
| | forced-alignment results. (Note: WSJ refers to Wall Street |
| | Journal speech corpus, a public dataset). |
| 9 | The difference between the duration of the last phone of the |
| | previous word of the focused position and the average duration |
| | of all the phones with the same manner of articulation as the |
| | last phone of the previous word and also at the end of words, |
| | computed from WSJ forced-alignment results. |

Feature set B may comprise 3 items, wherein processor(s) 20 may calculate a value for each checking position as a feature. Thus, there may be 3*2 or 6 features in feature set B.

| | |
|---|---|
| 1 | The manner of articulation of the last phone in the previous word of |
| | the focused position. The value is nominal, being one of {Vowel, |
| | Fricative, Nasal, Stop, Approximant, Silence). |
| 2 | The standard deviation of the duration of phones which are the same |
| | as the last phone of the previous word of the focused position, |
| | computed from WSJ forced-alignment results. |
| 3 | The standard deviation of the duration of phones which are of the |
| | same manner of articulation as the last phone of the previous word |
| | and also at the end of words, computed from WSJ forced-alignment |
| | results. |

Feature set C may comprise 1 feature, wherein it is calculated from a whole sentence.

| | |
|---|---|
| 1 | The speech rate of the sentence, defined as the number of syllables/ |
| | the sum of the duration of all voiced sections (pauses aren't taken into |
| | account in the denominator). |

Thus, block 820 makes a binary prediction based on signal speech data related to the two word boundaries as well as the whole utterance.

Following block 820, in block 830, processor(s) 20 may determine whether the first word boundary is TRUE. It will be appreciated that in a binary prediction, either the first word boundary is TRUE or the second word boundary is TRUE, but not both. If processor(s) 20 determine the first word boundary to be TRUE—i.e., a relative separation should be located at the first word boundary, the process 800 proceeds to block 840, else the process proceeds to block 870.

In block 840, it is determined that since the first word boundary is TRUE, the second boundary is FALSE.

In block 850 which follows, based on determining that the first word boundary is TRUE, the processor(s) 20 determine that an interpretation of the ambiguation should be based on Interpretation (1)—e.g., wherein the pause is at the first word boundary.

Thereafter, in block 860, the processor(s) 20 may provide any disambiguation data as output to the DMM 38 (e.g., according to block 645 of FIG. 6). Thereafter, the process may end.

Returning to block 870, in block 870, it is determined that since the first word boundary is FALSE, the second word boundary is TRUE.

In block 880 which follows, based on determining that the second word boundary is TRUE, the processor(s) 20 determine that an interpretation of the ambiguation should be based on Interpretation (2)—e.g., wherein the pause is at the second word boundary.

Thereafter, the processor(s) 20 may proceed again to block 860—and provide any disambiguation data as output to the DMM 38 (e.g., according to block 645 of FIG. 6, and process 800 may end.

Thus, any one of processes 700A, 700B, or 800 may be executed at block 640 of process 600 in order to determine the disambiguation. Each of processes 700A, 700B, or 800 may return disambiguation data (from the signal knowledge extraction model 34) to the ambiguation resolution model 68. And the ambiguation resolution model 68 may provide this data to the DMM 38, as previously described.

Recall that the hybrid architecture 50 shown in FIG. 2 may receive preliminary response P1 from end-to-end dialog system 52 or preliminary response P2 from task-specific dialog system 54. Accordingly, system 54 could utilize process 600 and any of processes 700A, 700B, or 800. Regardless, where at least two preliminary responses (e.g., P1, P2) are determined, the ranking of preliminary responses 58 may determine which of the responses is most appropriate using any suitable ranking technique (e.g., using scores, weights, etc.) and/or statistical analysis. Further, user, context, external, etc. data 56 also may influence the determination at ranking 58.

Finally, as shown in FIG. 2, the output 60 may be provided to the user based on a final response received from ranking 58 (e.g., via audio transceiver 18). Thereafter, the hybrid process may end. It will be appreciated that aspects of a spoken dialog system 10 may be task-oriented. For example, consider the table-top device 12. It may be given a command by the user—e.g., to operate an entertainment system or other connected device (e.g., internet-of-things (IoT) device). In this instance, system 54 may be equipped to handle such task-oriented commands. However, during such use, the user may use sarcasm or other emotion or emphasis which may not be processed as accurately by the task-specific dialog system 54. Here, the end-to-end dialog system 52 may provide—via preliminary response P1—a more accurate response; and according to the hybrid architecture 50, response P1 may be more accurate than response P2. Thus, hybrid architecture 50 facilitates task-oriented functions while accounting for a so-called human element.

Other embodiments are also possible. For example, either of processes 400 or 600 could be executed independently. For example, end-to-end dialog system 52 and task-specific dialog system 54 need not be part of the hybrid architecture 50. In these instances, preliminary responses P1, P2 may be the final responses provided by audio transceiver 18 to the user.

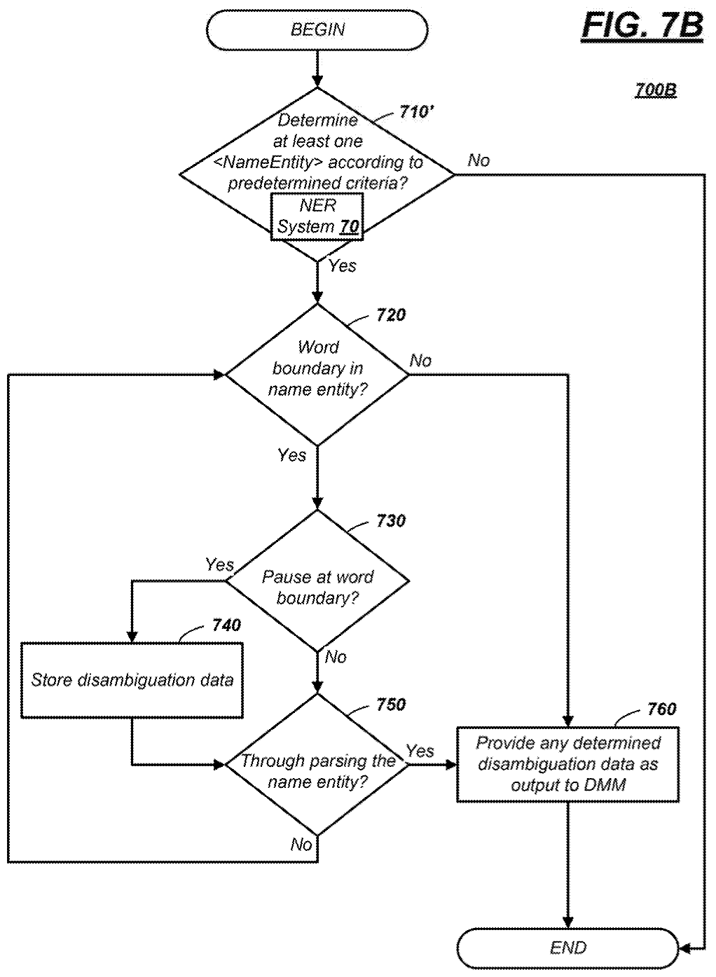

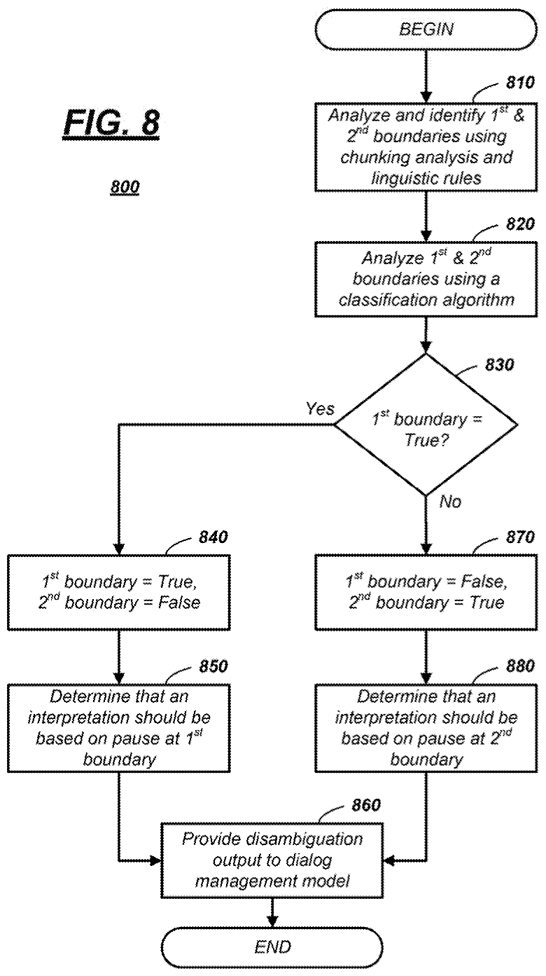

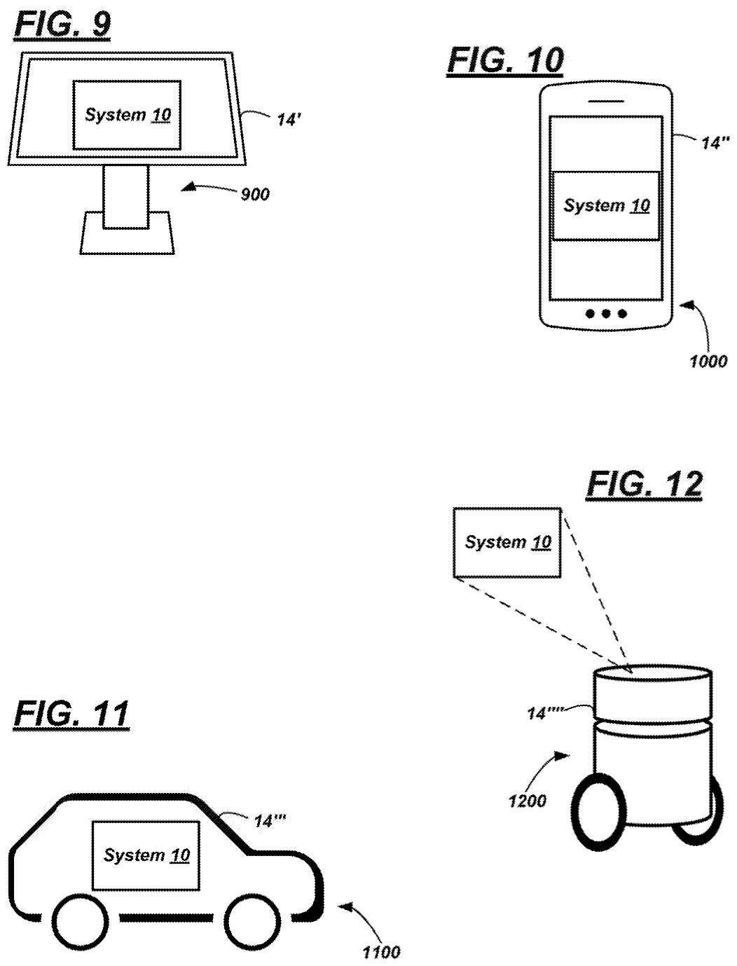

Still other embodiments exist. For example, any of one the end-to-end dialog system 52, the task-specific dialog system 54, or the hybrid architecture 50 may be embodied in other devices besides the table-top device 12. FIGS. 9-12 illustrate just a few non-limiting examples.

In FIG. 9, spoken dialog system 10 may be embodied within an interactive kiosk 900 having a housing 14′. Aspects of the dialog system 10 and its operation may be similar to the description provided above. Non-limiting examples of the kiosk 900 include any fixed or moving human-machine interface—e.g., including those for residential, commercial, and/or industrial use. A user may approach the kiosk 900, have a dialog exchange desiring task-specific information and/or communicate sarcasm in the dialog exchange, and the kiosk 900 (using dialog system 10) may not only generate and provide a response to the user but may also account for the user's sarcasm.

In FIG. 10, spoken dialog system 10 may be embodied within a mobile device 1000 having a housing 14″. Aspects of the dialog system 10 and its operation may be similar to the description provided above. Non-limiting examples of mobile devices 1000 include Smart phones, wearable electronic devices, tablet computers, laptop computers, other portable electronic devices, and the like. A user may approach the mobile device 1000, have a dialog exchange desiring task-specific information and/or communicate sarcasm in the dialog exchange, and the mobile device 1000 (using dialog system 10) may not only generate and provide a response to the user but may also account for the user's sarcasm.

In FIG. 11, spoken dialog system 10 may be embodied within a vehicle 1100 having a housing 14′″. Aspects of the dialog system 10 and its operation may be similar to the description provided above. Non-limiting examples of vehicle 1100 include a passenger vehicle, a pickup truck, a heavy-equipment vehicle, a watercraft, an aircraft, or the like. A user may approach vehicle 1100, have a dialog exchange desiring task-specific information and/or communicate sarcasm in the dialog exchange, and the vehicle 1100 (using dialog system 10) may not only generate and provide a response to the user but may also account for the user's sarcasm.

In FIG. 12, spoken dialog system 10 may be embodied within a robotic machine 1200 having a housing 14″″. Aspects of the dialog system 10 and its operation may be similar to the description provided above. Non-limiting examples of robotic machine 1200 include a remotely controlled machine, a partially autonomous, a fully autonomous robotic machine, or the like adapted for indoor or outdoor use. A user may approach the robotic machine 1200, have a dialog exchange desiring task-specific information and/or communicate sarcasm in the dialog exchange, and the robotic machine 1200 (using dialog system 10) may not only generate and provide a response to the user but may also account for the user's sarcasm.

Thus, there has been described a spoken dialog system that interacts with a user by receiving an utterance of the user, processing that utterance, and then generating a response. The dialog system may facilitate task-oriented communication, the processing of sarcastic speech, or both. Further, the dialog system may be adapted in a variety of machines—including but not limited to: a table-top device, a kiosk, a mobile device, a vehicle, or a robotic machine.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of response generation, comprising:
receiving audible human speech from a user;
determining textual speech data based on the audible human speech;
extracting, from the audible human speech, signal speech data that is indicative of acoustic characteristics which correspond to the textual speech data;
based on the textual speech data, determining, using a natural language understanding model, a text string comprising an ambiguation, wherein the ambiguation comprises a first interpretation of the text string and a second interpretation of the text string, wherein the first interpretation differs from the second interpretation;
determining the first interpretation is most accurate by corresponding word boundaries determined from the text string with the acoustic characteristics determined from the signal speech data; and
generating a response to the audible human speech based on the first interpretation.

2. The method of claim 1, wherein the signal speech data comprises at least one of sarcasm information, emotion information, pause information, or emphasis information.

3. The method of claim 1, further comprising determining the first interpretation using pause information in the signal speech data, wherein the pause information corresponds to at least one word boundary in the text string.

4. The method of claim 3, wherein determining the first interpretation further comprises: using a name entity recognition (NER) system to evaluate at least one Name Entity of the text string; and determining the pause information (of the signal speech data) at the at least one word boundary of the Name Entity.

5. The method of claim 4, wherein determining the first interpretation further comprises: determining the at least one Name Entity from among a plurality of Name Entities in the text string, wherein the at least one Name Entity is one of a B-<NameEntity> that is between a first threshold and a second threshold, or wherein the at least one Name Entity is one of an I-<NameEntity> that is between a third threshold and a fourth threshold.

6. The method of claim 4, wherein generating the response comprises:
generating a first preliminary response using the NER system;
determining a second preliminary response based on a sarcasm evaluation of the audible human speech; and
determining a final response based on a ranking of the first and second preliminary responses,
wherein the sarcasm evaluation comprises:
determining that a text-based sentiment is Positive or Neutral by processing the textual speech data using a text-based sentiment analysis tool;
determining that a signal-based sentiment is Negative by processing the signal speech data using a signal-based sentiment analysis tool; and
detecting sarcasm based on the text-based sentiment being Positive or Neutral while the signal-based sentiment is Negative.

7. The method of claim 6, wherein the second preliminary response is determined using an end-to-end neural network, wherein, when sarcasm is detected, an input to the neural network comprises a sarcasm token and a one-hot vector which represents that the audible human speech comprises sarcasm.

8. The method of claim 3, wherein determining the first interpretation further comprises: identifying a first word boundary and a second word boundary using a chunking analysis.

9. The method of claim 8, wherein determining the first interpretation further comprises: analyzing the first and second word boundaries using a classification algorithm.

10. The method of claim 9, wherein determining the first interpretation further comprises: determining a binary prediction that either the first word boundary or the second word boundary is most accurate.

11. The method of claim 10, wherein generating the response comprises:
generating a first preliminary response based on the chunking analysis;
determining a second preliminary response based on a sarcasm evaluation of the audible human speech; and
determining a final response based on a ranking of the first and second preliminary responses,
wherein the sarcasm evaluation comprises:
determining that a text-based sentiment is Positive or Neutral by processing the textual speech data using a text-based sentiment analysis tool;
determining that a signal-based sentiment is Negative by processing the signal speech data using a signal-based sentiment analysis tool; and
detecting sarcasm based on the text-based sentiment being Positive or Neutral while the signal-based sentiment is Negative.

12. The method of claim 11, wherein the second preliminary response is determined using an end-to-end neural network, wherein, when sarcasm is detected, an input to the neural network comprises a sarcasm token and a one-hot vector which represents that the audible human speech comprises sarcasm.

13. The method of claim 1, further comprising: prior to generating the response, evaluating, at a dialog management model the first interpretation in light of one or more of: sarcasm information, emotion information, emphasis information, data regarding the user, data regarding a context of the audible human speech, or external data relevant to the user or the audible human speech, wherein the external data comprises data regarding a time of the audible human speech, data regarding a location of the audible human speech, or both.

14. The method of claim 1, wherein the audible human speech is received via or the response is generated via one of: a table-top device, a kiosk, a mobile device, a vehicle, or a robotic machine.

15. A non-transitory computer-readable medium comprising a plurality of computer-executable instructions and memory for maintaining the plurality of computer-executable instructions, wherein the plurality of computer-executable instructions, when executed by one or more processors of a computer, perform the following function(s):
receive audible human speech from a user;
determine textual speech data based on the audible human speech;
extract, from the audible human speech, signal speech data that is indicative of acoustic characteristics which correspond to the textual speech data;
based on the textual speech data, determine, using a natural language understanding model, a text string comprising an ambiguation, wherein the ambiguation comprises a first interpretation of the text string and a second interpretation of the text string, wherein the first interpretation differs from the second interpretation;
determine the first interpretation is most accurate by corresponding word boundaries determined from the text string with the acoustic characteristics determined from the signal speech data; and
generate a response to the audible human speech based on the first interpretation.

16. The non-transitory computer-readable medium of claim 15, wherein the plurality of computer-executable instructions, when executed by the one or more processors of the computer, further perform the function(s) of: determining the first interpretation using pause information in the signal speech data, wherein the pause information corresponds to at least one word boundary in the text string.

17. The non-transitory computer-readable medium of claim 16, wherein determining the first interpretation further comprises: using a name entity recognition (NER) system to evaluate at least one Name Entity of the text string; and determining the pause information (of the signal speech data) at the at least one word boundary of the Name Entity.

18. The non-transitory computer-readable medium of claim 17, wherein
generating the response comprises:
generating a first preliminary response using the NER system;
determining a second preliminary response based on a sarcasm evaluation of the audible human speech; and
determining a final response based on a ranking of the first and second preliminary responses,
wherein the sarcasm evaluation comprises:
determining that a text-based sentiment is Positive or Neutral by processing the textual speech data using a text-based sentiment analysis tool;
determining that a signal-based sentiment is Negative by processing the signal speech data using a signal-based sentiment analysis tool; and
detecting sarcasm based on the text-based sentiment being Positive or Neutral while the signal-based sentiment is Negative.

19. The non-transitory computer-readable medium of claim 16, wherein determining the first interpretation further comprises: identifying a first word boundary and a second word boundary using a chunking analysis.

20. A method of response generation, comprising:
receiving audible human speech from a user;
determining textual speech data based on the audible human speech;
extracting, from the audible human speech, signal speech data that indicative of acoustic characteristics which correspond to the textual speech data;
using a text-based sentiment analysis tool, determining that a sentiment analysis of the textual speech data is Positive or Neutral;
using a signal-based sentiment analysis tool, determining that a sentiment analysis of the signal speech data is Negative; and
based on the sentiment analyses of the textual and signal speech data, determining that the audible human speech comprises sarcasm.
